(19) United States
(12) Patent Application Publication
(10) Pub. No.: US 2009/0301227 A1
(43) Pub. Date: Dec. 10, 2009

(54) Liquid Contact Structure, Structure for Controlling Movement of Liquid and Method of Controlling Movement of Liquid

(76) Inventors: Wataru Hattori, Tokyo (JP); Hisao Kawaura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/085,838

(22) PCT Filed: Nov. 24, 2006
(86) PCT No.: PCT/JP2006/323420

§ 371 Date: May 30, 2008

(30) Foreign Application Priority Data
Dec. 8, 2005 (JP) 2005 354932

(51) Int. Cl. G01N 1/28; G01N 27/62

(52) U.S. Cl. 73/863; 250/281

(57) ABSTRACT

Liquid contact structure 1 includes lyophilic surface 2 which is provided with a plurality of convex structures 3 and which is adapted to come into contact with a predetermined liquid. Surface 2 has lyophilicity that varies depending on regions of 2 surface according to a difference in a surface area multiplication factor which is caused by convex structures 3, wherein surface 2 is formed to have highest lyophilicity within predetermined region 4 on surface 2.

### TECHNICAL FIELD

The present invention relates to a liquid contact structure, a structure for controlling movement of liquid and a method for controlling movement of liquid, and particularly to a liquid contact structure for concentrating a sample on a target plate of a mass spectrometer.

### BACKGROUND ART

A matrix-assisted laser desorption ionization mass spectrometer has been widely used for the measurement of molecular weight of protein or peptide. When a sample that includes protein or peptide is measured by the spectrometer, crystals of a reagent for promoting ionization, which is called a matrix, are formed, together with the sample, in a predetermined well that is arranged on the target plate.

Various methods for forming crystals have been known. According to one method, a solution that includes a sample is first dripped onto a well and then a solution in which a reagent for promoting ionization called a matrix is dissolved is dripped thereon. As the solvent of the matrix solution dries while dissolving the sample, the matrix, which is a solute, is precipitated together with the sample, and crystals are formed. According to another method, a solution in which a sample and a matrix are dissolved is formed in advance, and the mixed solution is then dripped onto a well. The solvent is dried, and thereby crystals of the matrix that include the sample are precipitated.

The well for forming crystals of a matrix is formed in a circular shape having a diameter of, for example, 2 mm because a liquid requires being dripped by a pipet, as described above. The well has a larger area than an irradiation area (typically having a diameter of approximately 100 μm) that is irradiated with a laser in order to ionize the sample. Accordingly, the amount of ionized sample is limited as compared to the quantity of the dripped sample. This may degrade the sensitivity of the laser desorption ionization mass spectrometer.

In order to solve this problem, Bruker Daltonics Inc. has developed and marketed a target plate called “Anchor Chip” illustrated in FIG. 6. Well 107 formed on the target plate has a liquid repellent coating on the entire surface thereof except for the central area in which the coating is partially removed to form lyophilic area 121, as illustrated in the partial enlarged view of the well in FIG. 7. The term “lyophilic” used herein means that a flat surface formed of a certain material has a contact angle that is less than 90 degrees with respect to the liquid that is dripped onto the flat surface. On the other hand, the term “liquid repellent” means that the flat surface has a contact angle that is more than 90 degrees under the above condition.

When a sufficiently thin solution, in which a sample and a matrix are dissolved in a solvent, is dripped onto the well, a droplet is reduced in size as the solvent dries. In this process, since the liquid does not stay in the liquid repellent area, the crystal is only precipitated in the lyophilic area, as shown in FIG. 8, which is an enlarged view of the center of a well. The term “sufficiently thin” used herein means that a solute is diluted with a solvent to the extent that crystals of a matrix are not precipitated until the solution is concentrated in the lyophilic area. If a solute is insufficiently diluted, crystals will be precipitated before droplets are concentrated in the lyophilic area, and crystals will be physically caught on rough parts of the surface even in the liquid repellent area. As a result, crystals are not completely concentrated in the lyophilic area.

The use of the Anchor Chip enables crystals to be formed in a concentrated area that is sufficiently smaller in size than the well and thereby enables a dramatic improvement in the usage efficiency of the sample. As a result, a decrease in sensitivity of the laser desorption ionization mass spectrometer can be limited. It should be noted that gathering crystals that include samples on the well may be expressed by the words “a sample is concentrated” in this technical field.

A target plate for a mass spectrometer is mainly described above, and hitherto, a coating is required to control liquid repellency or lyophilicity of a surface in order to control the position and movement of a droplet that is dried.

### Patent Document 1: Japanese Patent Laid-Open Publication No. 150543/96

### Patent Document 2: Japanese Patent Laid-Open Publication No. 2004-533564

Non-Patent Document 1: Jun Liu, et al., “Electrophoresis separation in open microchannels. A method for coupling electrophoresis with MALDI-MS,” Analytical Chemistry, Vol. 73 (2001), pp. 2147-2151.

### DISCLOSURE OF THE INVENTION

### Problem to be Solved

However, because of the recent developments in biotechnology, the method for concentrating a sample using a coating, such as the Anchor Chip mentioned above, may be inapplicable.

For example, Non-Patent Document 1 discloses a technique to separate a protein sample in an open channel that is provided on an electrophoresis chip and to detect the protein sample, which is separated in the channel, by means of a laser desorption ionization mass spectrometer. The width of the channel that is disclosed in the document is 150 μm or 250 μm. Since the width of the channel is larger than the laser diameter of a mass spectrometer, which is typically about 100 μm, an improvement in sensitivity can be expected if the sample is concentrated. However, the channel requires a lyophilic inner surface in order to hold a sample solution therein for the purpose of electrophoresis, and therefore, a liquid repellent coating can not be applied to the inner surface of the channel.

In recent years, a technique for analyzing a trace of a sample, such as a gaseous C-terminal analysis technique, has been developed, in which various reactions are caused directly on a target plate and the results of the reactions are finally detected by a mass spectrometer. For example, in this technique, chemicals are carried in a gaseous state and are reacted with a sample on a target plate. However, a coating that is made of polymeric resin can not be used depending on the kind of chemicals. A target plate is typically made of stainless steel, but some kinds of chemicals require glass for a physical and chemical appliance. In these cases, the Anchor Chip technique cannot be used.

As will be understood from the two examples described above, there are cases in which a sample cannot be concentrated by the Anchor Chip technique described above. It should be noted that use of a sample concentration is not limited to the field that uses the mass spectrometer for detection, which is mainly described above. Gathering a sample into an area leads to an improvement in sensitivity, for example, when a sample with a fluorescent label is detected by the fluorescence detection technique or when a sample is detected by using absorption of light. Also, when a protein crystal is required for the purpose of measuring the structure of the protein by means of the X-ray analysis, a technique for drying a solution and for concentrating a sample into an area to obtain as large crystals as possible is desired. Thus, the technique for drying a liquid while controlling the position and movement of the liquid is used in various fields, but there is a need for a liquid contact surface that has no coating.

The present invention was made under the circumstances mentioned above. An object of the present invention is to provide a technique for evaporating a liquid while controlling the position and movement thereof on the face of the liquid contact structure, wherein the technique requires no coating and has a simple configuration.

### DISCLOSURE OF THE INVENTION

A liquid contact structure according to the present invention comprises a lyophilic surface which is provided with a plurality of convex structures and which is adapted to come into contact with a predetermined liquid. The surface has lyophilicity that varies depending on regions of the surface according to a difference in a surface area multiplication factor which is caused by the convex structures, wherein the surface is formed to have highest lyophilicity within a predetermined region on the surface.

Another liquid contact structure according to the present invention comprises a lyophilic surface which is provided with a plurality of convex structures and which is adapted to come into contact with a predetermined liquid. The surface has lyophilicity that varies depending on regions of the surface according to a difference in a surface area multiplication factor which is caused by the convex structures, wherein the surface is formed to have highest lyophilicity within a region which surrounds a predetermined region on the surface and which is adjacent to the predetermined region.

The convex structures that are formed increase the area of the surface, measured per projected area, of the region in which the convex structures are formed because the area of the side surfaces of the convex structures is added to the area of the surface. The surface area multiplication factor indicates the rate of the increase in the area of the surface that is measured per unit of the projected area. Since the base plate that forms the convex structures has a surface that is lyophilic with respect to the predetermined liquid, the lyophilicity is further increased due to the increase in the area of the surface. When a liquid is dried and decreases in volume, the liquid shrinks while moving toward a high lyophilic area, i.e., toward an area having a high surface area multiplication factor. Since the surface is formed to have the highest lyophilicity within the predetermined region, the liquid is finally concentrated in this region. Alternatively, since the surface is formed to have the highest lyophilicity within a region which surrounds the predetermined region and which is adjacent to the predetermined region, the liquid is finally concentrated in this region. Thus, effective concentration of a liquid can be achieved in a simple configuration.

The surface may be configured such that the lyophilicity in a vicinity of the region having the highest lyophilicity monotonously increases toward the region having the highest lyophilicity.

Density of the convex structures that consist of substantially the same shape may vary depending on the regions, and thereby the surface may have the lyophilicity that varies depending on the regions.

The surface may be provided with fan-shaped convex structures which are spaced apart from each other and which radially extend toward the predetermined region, and thereby the surface may have the lyophilicity that varies depending on the regions.

A structure for controlling movement of a liquid according to the present invention comprises a plurality of the liquid contact structures mentioned above which are arranged on the surface.

A method for controlling movement of a liquid according to the present invention comprises: a step of providing a liquid contact structure comprising a lyophilic surface which is provided with a plurality of convex structures and which is adapted to come into contact with a predetermined liquid; wherein, the lyophilicity on the surface varies depending on regions of the surface according to a difference in a surface area multiplication factor that is caused by the convex structures, a step of dripping the predetermined liquid onto a predetermined region of the surface that includes a region having highest lyophilicity; and a liquid moving step of concentrating the predetermined liquid within the region having the highest lyophilicity while evaporating the predetermined liquid.

The predetermined liquid may include a solvent and a solid solute that is dissolved in the solvent. In this case, the liquid moving step may include evaporating the solvent and precipitating the solute within a region having a largest surface area multiplication factor or within an inside region thereof.

As described above, according to the present invention, a technique for evaporating a liquid while controlling the position and movement thereof on the face of the liquid contact structure, wherein the technique requires no coating and has a simple configuration, can be provided.

### BRIEF DESCRIPTION OF THE DRAWINGS

FIG. 1 is a schematic perspective view of a liquid contact structure according to a first exemplary embodiment of the present invention;

FIG. 2A is a plan view of a liquid contact structure according to a second exemplary embodiment of the present invention;

FIG. 2B is a partial perspective view of the liquid contact structure shown in FIG. 2A;

FIG. 3 is a schematic perspective view of the liquid contact structure according to the second exemplary embodiment of the present invention;

FIG. 4 is a plan view of a sample analyzing chip according to a third exemplary embodiment of the present invention;

FIG. 5 is a plan view of a modified exemplary embodiment of the sample analyzing chip illustrated shown in FIG. 4;

FIG. 6 is a view illustrating an example of the Anchor Chip according to related art;

FIG. 7 is an enlarged view of a well of the Anchor Chip shown in FIG. 6; and

FIG. 8 is a view illustrating a matrix that is concentrated by means of the Anchor Chip shown in FIG. 6.

### DESCRIPTION OF SYMBOLS

1 Liquid contact structure
2, 2a Surface
3, 3a, 3b Convex structure
4, 4a, 4b Predetermined region
5a Region
6 Movement control structure
7, 107 Well
8 Chip
9 Channel
10 General region
11 Connecting region
13 Flat portion
14 Convex structure group
15 Side surface
121 Lyophilic area

### BEST MODE FOR CARRYING OUT THE INVENTION

Exemplary embodiments of the present invention will be described with reference to the drawings. In all the figures, similar reference numerals are given to the same components, and descriptions of the components may be omitted.

### First Exemplary Embodiment

FIG. 1 is a schematic perspective view of a liquid contact structure according to a first exemplary embodiment of the present invention. Liquid contact structure 1 is a bottom structure of a liquid storage portion (not shown) on a target plate of a mass spectrometer. The base plate (not shown) of liquid contact structure 1 has lyophilic surface 2 which is provided with a plurality of convex structures 3 and which is adapted to come into contact with a liquid. The area of the surface, measured per unit of the projected area, of a region in which convex structures 3 are formed increases by the area of the side surfaces of convex structures 3 that is added, as compared with an area which would be obtained if the region was flat. The ratio of the increase in the area of the surface is referred to as a “surface area multiplication factor.” The surface area multiplication factor is defined as a value which is obtained by dividing an increase in the area of the surface, which is obtained by convex structures 3, by the projected area of the region in which convex structures 3 is formed.

The lyophilicity on surface 2 varies among regions of surface 2 depending on the difference in the surface area multiplication factor that is caused by convex structures 3. In the present exemplary embodiment, an array structure of convex structures 3 is formed on surface 2, and the region in which the array structure is formed has improved lyophilicity as compared with a region in which the array structure is not formed. Surface 2 has inherent Iyophilicity for a certain kind of a liquid, but the effect of the increase in the area of the surface further improves the degree of lyophilicity. It should be noted that the term “lyophilicity” used herein means lyophilicity with respect to a liquid to be handled.

In the present exemplary embodiment, the surface is formed to have the highest lyophilicity in predetermined region 4 of the surface. Predetermined region 4 in the present exemplary embodiment corresponds to the region in which the array of convex structures 3 is provided. The surface area multiplication factor exhibits a larger value within predetermined region 4 that includes the array structure than in flat regions in the vicinity of predetermined region 4. The term “vicinity” used herein means regions to which a liquid may extend. A liquid gradually decreases in volume while being evaporated and dried. A liquid tends to stay in regions having high lyophilicity and tends to move in regions having low lyophilicity. Accordingly, a liquid that is being dried moves to regions having high lyophilicity and is concentrated into predetermined region 4 which has the highest lyophilicity.

The liquid contact structure of the present exemplary embodiment can be used as described below. First, the liquid contact structure mentioned above is prepared. Next, a liquid having a sufficient volume to cover the array structure is dripped so that the liquid comes into contact with at least the array of convex structures 3 on surface 2. In other words, considering that the array structures correspond to the region having the highest lyophilicity, the liquid is dripped onto the predetermined region on the surface that includes the region having the highest lyophilicity with respect to the liquid. The dripped liquid forms a droplet on surface 2. The droplet exhibits a contact angle that is less than 90 degrees due to the lyophilicity of surface 2. However, surface 2 preferably does not have too high lyophilicity so that the droplet does not extend too much. The lyophilicity of surface 2 is desirably adjusted such that the contact angle is preferably 30 degrees or more and 90 degrees or less, and more preferably, 45 degrees or more and 90 degrees or less. Surface 2 more preferably has low lyophilicity with a contact angle that is close to 90 degrees in order to limit the surface adsorption of protein or peptide. If a liquid includes protein or peptide, then a lyophilic coating to inhibit adsorption, such as coating using phospholipid bilayer, may be used.

Subsequently, the liquid is dried while being evaporated. When the dripped liquid is dried and the droplet becomes small, the portion of the droplet that has smaller adsorptivity between the surface and the droplet tends to move first. The region in which the droplet is in contact with the array of convex structures 3 has a larger contact area with the liquid, measured per unit of the projected area, by the increment of the surface area multiplication factor. In other words, this region generates a larger adsorptive force between the surface and the droplet, measured per unit of the projected area, by the increment of the surface area multiplication factor that is caused by convex structures 3. Therefore, when the droplet is evaporated and shrinks, the droplet in the region in which the droplet is in contact with the array of convex structures 3 does not move, but the droplet in other regions moves. As a result, the droplet that is evaporated and that is reduced in size is concentrated (gathered) and shrinks into the region that has the array of convex structures 3, i.e., into the region having the highest lyophilicity. In other words, the liquid is gathered within predetermined region 4 that includes the array structure.

If a liquid that forms a droplet is a solution in which a solid solute is dissolved in a solvent, the droplet shrinks and is concentrated within predetermined region 4 without the solute being precipitated until the concentration of the solution is saturated. If the concentration of the solution is sufficiently low and the solute is precipitated after the solution is concentrated within predetermined region 4, then the solute is concentrated and precipitated within predetermined region 4, i.e., within the region having the largest surface area multiplication factor. In other word, as regards concentration of a sample, the same effect as achieved by the Anchor Chip technique is achieved but without a coating.

It should be noted that it may be possible to provide a coating in order to enhance the lyophilicity depending on the property of a liquid that is to be handled. In this case, the surface of convex structures 3 may have a coating. Surface 2 may also have a coating which gradually increases the lyophilicity toward predetermined region 4 having the largest surface area multiplication factor so that an even larger effect can be expected.

### Second Exemplary Embodiment

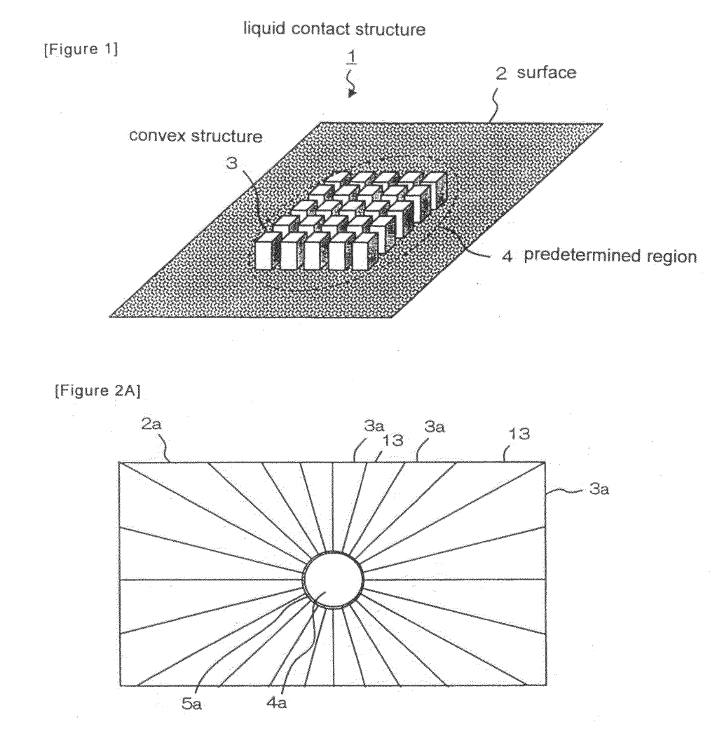

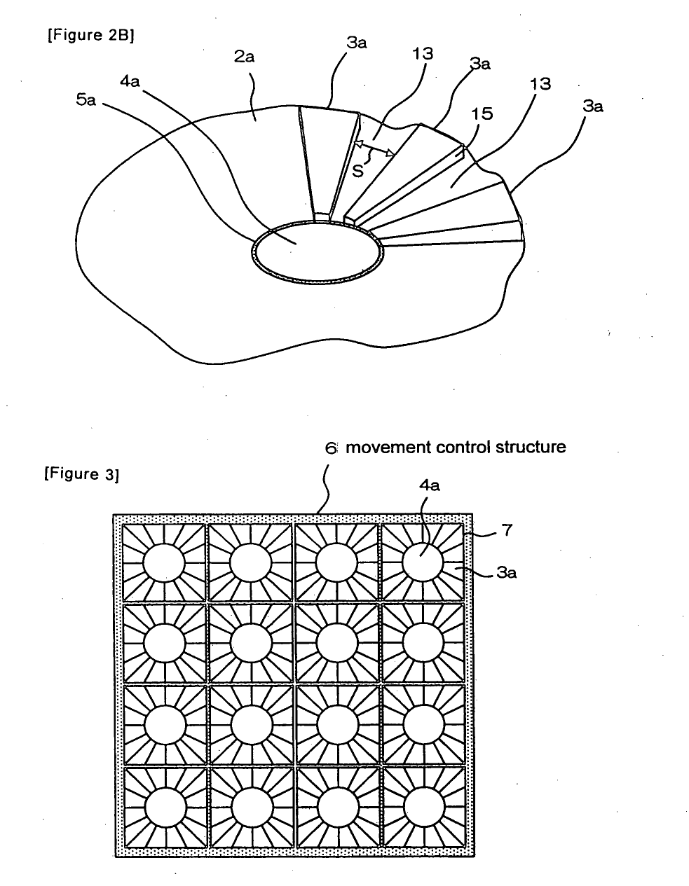

FIG. 2A is a plan view illustrating a liquid contact structure according to a second exemplary embodiment. FIG. 2B is a perspective view of the liquid contact structure partially illustrating the convex structures. Many fan-shaped convex structures 3a having certain heights are provided on surface 2a. Being spaced apart from each other, convex structures 3a radially extend toward predetermined circular region 4a that is located on the central portion of the base plate. The regions located between convex structures 3a are flat portions 13. This arrangement can be obtained by etching a base plate made of glass based on the fine processing technique for semiconductors. Embossing, press working and machining may also be used depending on the materials. Surface 2a that includes convex structures 3a is lyophilic, similar to the first exemplary embodiment. Surface 2a may also have a coating mentioned above in order to inhibit adsorption of protein etc.

Also, in the present exemplary embodiment, surface 2a has lyophilicity that varies depending on the regions of surface 2a according to a difference in the surface area multiplication factor that is caused by convex structures 3a. In other words, distance S between adjacent convex structures 3a gradually decreases toward predetermined region 4a, and the area of side surfaces 15 of convex structures 3a per unit area relatively increases in accordance with a decrease in distance S. As a result, the surface area multiplication factor, as well as the lyophilicity, of surface 2a monotonously increases toward predetermined region 4a. In other words, they increase as the radius, measured from the center of the radial structure, becomes smaller. It should be noted that the term “a monotonous increase” includes a stepwise increase, as well as a continuous increase. The surface area multiplication factor and the lyophilicity have maximum values in region 5a that surrounds and that is adjacent to predetermined region 4a. The center of the radial structure may be eccentric with the center of predetermined region 4a, as long as the above relationship is satisfied. Region 4a that is located at the center of the radial pattern is not limited to a circular shape, and may have a polygon shape, such as a hexagon, a rectangle, or other desired shapes. Similarly, the radial pattern, in turn, is not limited to a concentric circle, and may have various desired shapes, such as a concentric hexagon or an eccentric rectangle.

Suppose that a liquid is dripped to come into contact with at least predetermined region 4a. The dripped liquid forms a droplet on surface 2a. The droplet has a contact angle that is less than 90 degrees because of the lyophilicity of surface 2a. As evaporation and shrinkage of the droplet progresses, the portion of the droplet that has small adsorptivity between surface 2a and the droplet tends to move first. As a result, the droplet starts to move from the outer portion of the radial structure and shrinks toward the center of the structure. In the present exemplary embodiment, the droplet smoothly shrinks toward the center of the radial structure because the surface area multiplication factor monotonously increases toward predetermined region 4a without showing the maximum value outside region 5a. Once the sample liquid is concentrated within region 5a, the liquid does not extend outwardly again because the surface area multiplication factor has the maximum value in region 5a. Predetermined region 4a functions as a stabilizing area after the sample liquid is concentrated within region 5a, and thereby the sample is gathered within region 4a. As described above, the surface area multiplication factor has the maximum value in region 5a in the vicinity of predetermined region 4a, and as a result, the liquid that is dripped onto the region in the vicinity of predetermined region 4a shrinks toward region 5a and is concentrated within predetermined region 4a that is defined by region 5a.

As described above, the present exemplary embodiment enables, with a simple configuration, precise control of the position and movement of a liquid that is evaporated on a surface without providing a coating that varies depending on the locations. It should be noted that the present exemplary embodiment, similar to other embodiments, achieve the effect of concentrating a sample liquid in which a solid solute is dissolved in a solvent without providing a coating. Needless to say, a coating may be provided, similar to the first exemplary embodiment, depending on the property of the liquid that is to be handled in order to increase the lyophilicity.

A plurality of wells, each of which is a liquid contact structure, may be arranged on the surface. FIG. 3 is a plan view of the structure for controlling movement of a liquid thus configured. A plurality of wells 7 are provided on movement control structure 6, and radial convex structures 3a are formed within each well 7. The present exemplary embodiment can be applied, for example, to a target plate that usually has a plurality of wells arranged thereon. A droplet is preferably dripped such that it does not extend to more than one well 7. By dripping the droplet such that it does not extend to a region in the vicinity of predetermined region 4a of well 7, onto which the droplet is dripped, and of the predetermined region of another well that is adjacent to the well, more than one liquids can be handled on one plate without causing mixture of liquids. Furthermore, the present exemplary embodiment, when applied to the channel that is disclosed in Non-Patent Document 1, enables samples to be concentrated in respective predetermined regions, provided that the predetermined regions are arranged at intervals that are sufficient to realize desired separability.

### Third Exemplary Embodiment

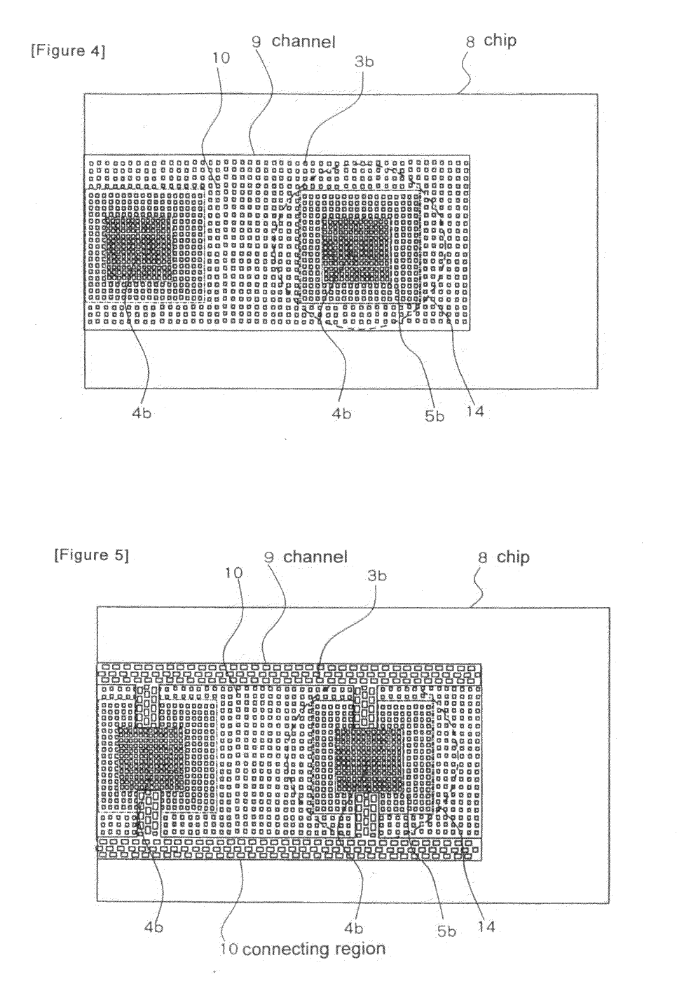

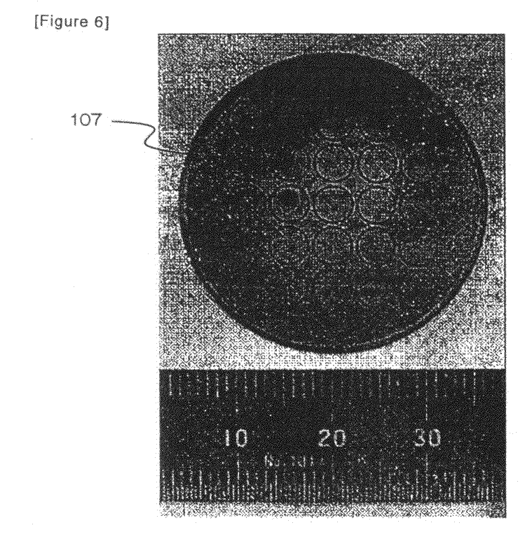

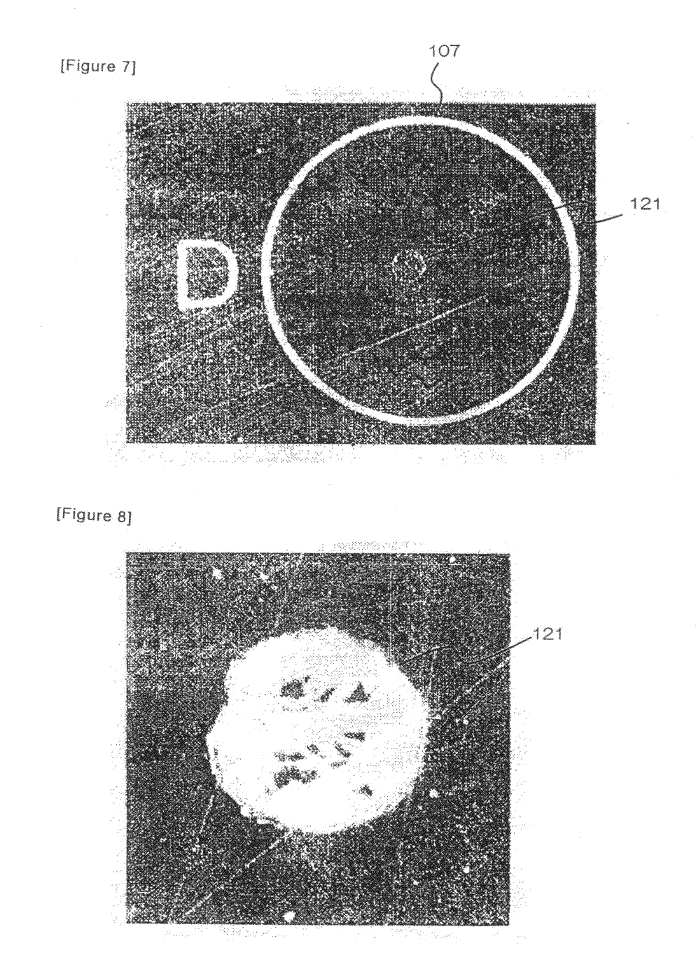

FIG. 4 is a plan view illustrating part of a channel for a sample analyzing chip. Channel 9 is formed on chip 8. Convex structures 3b having column shapes, similar to the ones illustrated in the first exemplary embodiment, are formed on the bottom surface of channel 9. Convex structures 3b are arranged such that the density thereof increases stepwise as it becomes closer to predetermined region 4b. Convex structures 3 having the largest density are arranged within predetermined region 4b. Accordingly, the surface within predetermined region 4b has a larger surface area multiplication factor than the surfaces in the regions in the vicinity of predetermined region 4b, and the surface within predetermined region 4b also has the highest lyophilicity. Such convex structure groups 14 are arranged on chip 8 along the longitudinal direction of channel 9.

In the figure, peripheral region 5b, in which convex structures 3b having smaller density are arranged is provided outside predetermined region 4b, and general region 10, in which convex structures 3b having still smaller density are arranged is provided outside peripheral region 5b. The density of convex structures 3b may vary in more steps or may continuously vary. Convex structures 3b are arranged such that protrusions having approximately the same dimension and having varying density are arranged, but may be arranged according to other methods, such as one that uses protrusions that gradually vary in dimensions, as long as varying lyophilicity can be obtained by gradually changing the area of the surface. The inner wall of channel 9 preferably has a lyophilic coating in order to limit electroosmotic flow. Predetermined region 4b may be formed along the wall of channel 9, instead of being formed at the center of channel 9. This arrangement enables effective use of the lyophilic side surface of channel 9.

It is possible to detect protein by using channel 9 to perform isoelectric focusing of a sample that includes protein, then by adding a matrix to the sample, and thereafter by performing the mass spectrometry. Because of the increased lyophilicity of channel 9 that is caused by convex structures 3b provided on channel 9, stable electrophoresis can be performed without the need of providing a lid on the channel, for example, by performing the operation under an increased solvent vapor pressure in a closed chamber. It is possible to concentrate protein at an isoelectric point and to precipitate the protein by filling channel 9 with a solution that includes protein to which ampholyte is added, and by applying a voltage at both ends of electrolyte that is supplied.

After the isoelectric focusing of the sample is completed, the sample in the channel is dried without the separation pattern thereof disturbed. In this process, freeze-drying of the sample is preferably performed, for example, after quick freezing. Thereafter, a matrix is added to the precipitated sample in order to analyze the sample by using a laser desorption ionization mass spectrometer. A dispenser or an inkjet device may be used to add a matrix solution in a significantly small amount that is on the order from several pL to several nL in one operation. In other words, it is possible to form a droplet such that it only covers one convex structure group 14 that includes one predetermined region 4b by adjusting the amount of liquid. The added droplet is dried while dissolving the freeze-dried sample and is gathered into predetermined region 4b of convex structure group 14 onto which the droplets are dripped. As a result, the crystals of the matrix that includes the sample are precipitated in predetermined region 4b. Subsequently, the crystals are irradiated with a laser and a mass analysis is performed on the crystals in order to detect the sample with high accuracy.

It is desirable that channel 9 has a property to induce a liquid flow in the longitudinal direction of the channel. For this purpose, connecting region 11 having high density convex structures that connect adjacent predetermined regions 4b to each other may be disposed, as illustrated in FIG. 5. In order to prevent a matrix solution from extending, the space between adjacent predetermined regions 4b may be provided with general region 10 having low density convex structures, or may be provided with a region having still lower lyophilicity than general region 10.

1. A liquid contact structure comprising a lyophilic surface which is provided with a plurality of convex structures and which is adapted to come into contact with a predetermined liquid, wherein,
the surface has lyophilicity that varies depending on regions of the surface according to a difference in a surface area multiplication factor which is caused by the convex structures, wherein the surface is formed to have highest lyophilicity within a predetermined region on the surface, wherein the surface is configured such that the lyophilicity in a vicinity of the region having the highest lyophilicity monotonously increases toward the region having the highest lyophilicity.

2. A liquid contact structure comprising a lyophilic surface which is provided with a plurality of convex structures and which is adapted to come into contact with a predetermined liquid, wherein,
the surface has lyophilicity that varies depending on regions of the surface according to a difference in a surface area multiplication factor which is caused by the convex structures, wherein the surface is formed to have highest lyophilicity within a region which surrounds a predetermined region on the surface and which is adjacent to the predetermined region, wherein the surface is configured such that the lyophilicity in a vicinity of the region having the highest lyophilicity monotonously increases toward the region having the highest lyophilicity.

3. (canceled)

4. The liquid contact structure according to, claim 1, wherein a density of the convex structures that have substantially a same shape varies depending on the regions, and thereby the surface has the lyophilicity that varies depending on the regions.

5. The liquid contact structure according to, claim 1, wherein the surface is provided with fan-shaped convex structures which are spaced apart from each other and which radially extend toward the predetermined region, and thereby the surface has the lyophilicity that varies depending on the regions.

6. A structure for controlling movement of a liquid comprising a plurality of the liquid contact structures according to claim 1, which are arranged on the surface.

7. A method for controlling movement of a liquid comprising:
providing a liquid contact structure comprising a lyophilic surface which is provided with a plurality of convex structures and which is adapted to come into contact with a predetermined liquid; wherein, the lyophilicity on the surface varies depending on regions of the surface according to a difference in a surface area multiplication factor that is caused by the convex structures;
dripping the predetermined liquid onto a predetermined region of the surface that includes a region having highest lyophilicity; and
a liquid moving of concentrating the predetermined liquid within the region having the highest lyophilicity while evaporating the predetermined liquid.

8. The method for controlling movement of a liquid according to claim 7, wherein
the predetermined liquid includes a solvent and a solid solute that is dissolved in the solvent, and
the liquid moving includes evaporating the solvent and precipitating the solute within a region having a largest surface area multiplication factor or within an inside region thereof.

9. The liquid contact structure according to claim 2, wherein a density of the convex structures that have substantially a same shape varies depending on the regions, and thereby the surface has the lyophilicity that varies depending on the regions.

10. The liquid contact structure according to claim 2, wherein the surface is provided with fan-shaped convex structures which are spaced apart from each other and which radially extend toward the predetermined region, and thereby the surface has the lyophilicity that varies depending on the regions.

11. A structure for controlling movement of a liquid comprising a plurality of the liquid contact structures according to claim 2 which are arranged on the surface.
